(19) United States
(12) Patent Application Publication
(10) Pub. No.: US 2021/0024224 A1
(43) Pub. Date: Jan. 28, 2021

(54) SYSTEMS AND METHODS FOR AUTOMATICALLY RECORDING INTERACTIVITY AND ANOMALY DATA AT A VEHICLE

(71) Applicant: Honeywell International Inc., Morris Plains, NJ (US)

(72) Inventors: Rajeev MOHAN, Bangalore (IN); Kalimulla Khan, Morris Plains, NJ (US); Raghu Shamasundar, Bangalore (IN); Nayyar Azam Khan Rao, Bangalore (IN); Srihari Jayathirtha, Bangalore (IN)

(21) Appl. No.: 16/517,977

(22) Filed: Jul. 22, 2019

(51) Int. Cl. B64D 45/00; G07C 5/08; G07C 5/00

(52) U.S. Cl. CPC B64D 45/00; G07C 5/0808; B64D 2045/0075; G07C 5/008; G07C 5/085

(57) ABSTRACT

Disclosed are systems, methods, and non-transitory computer-readable medium for automatically capturing and recording anomalies and vehicle operator interaction data. For example, a method may comprise receiving external operational data associated with operation of a vehicle, detecting loading of one or more applications associated with the operation of the vehicle, capturing one or more interactions between an operator of the vehicle and the one or more applications at the vehicle, logging anomalies data associated with the operation of the vehicle, based on any anomaly identified from the received external operational data, the detected loading of the one or more applications, or the captured one or more interactions, recording the received external operational data, the detected loading of the one or more applications, the captured one or more interactions, and/or the logged anomalies data, to generate recorder data, storing the generated recorder data in one or more vehicle data recorder databases.

### TECHNICAL FIELD

Various embodiments of the present disclosure generally relate to recording vehicle data, and more particularly, to automatically capturing and storing interactivity and anomaly data at a vehicle to generate electronic analytics data.

### BACKGROUND

Current vehicle operational data analysis systems, such as FOQA (flight operational quality assurance) systems, utilize various models for assessing the quality of vehicle operations, including, for example, detecting deviations from SOPs (standard operating procedures), recording vehicle related events, identifying envelope exceedances, and monitoring airworthiness of the vehicles (e.g., aircraft). Parameters and outputs from these models may be analyzed, both during and after the operation, for evaluating and/or visualizing the quality of performance. Because the objective of the analysis is often to recreate the vehicle's operation as closely to the real as possible, these systems often focus on external events that occurred during the operation (e.g., weather-related events), outputs of vehicle sensors during the operation, and/or data fed from LRUs (line-replaceable unit) during the vehicle's operation.

However, because of evolving reliance on computer-implemented tools by vehicle operators (e.g., electronic flight bag (EFB) system), vehicles' operations may also be heavily affected by how effectively the operator (e.g., pilot) interacts with software applications in these tools. Thus, records indicative of vehicle operators' interactions with these applications (e.g., a pilot's interactions with electronic flight bag (EFB) applications), if available, may allow for analytics with enhanced accuracy and effectiveness of these post-operation quality assessments. Thus, it is highly desirable for vehicle operational data analysis systems to capture and record an operator's interactivity data, to analyze in conjunction with other operational data captured by the vehicle operational data analysis systems.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed to automatically recording interactivity and anomaly data at a vehicle, based at least in part on capturing the vehicle operator's interactions with applications.

In one embodiment, a computer-implemented method is disclosed for automatically capturing and recording anomalies and vehicle operator interaction data. The computer-implemented system may comprise: receiving, by one or more processors, external operational data associated with operation of a vehicle; detecting, by the one or more processors, loading of one or more applications associated with the operation of the vehicle; capturing, by the one or more processors, one or more interactions between an operator of the vehicle and the one or more applications at the vehicle; logging, by the one or more processors, anomalies data associated with the operation of the vehicle, based on any anomaly identified from the received external operational data, the detected loading of the one or more applications, or the captured one or more interactions; recording, by the one or more processors, the received external operational data, the detected loading of the one or more applications, the captured one or more interactions, and/or the logged anomalies data, to generate recorder data; and storing, by the one or more processors, the generated recorder data in one or more vehicle data recorder databases.

In accordance with another embodiment, a computer system is disclosed for automatically capturing and recording anomalies and vehicle operator interaction data. The computer system may comprise: a memory having processor-readable instructions stored therein; and at least one processor configured to access the memory and execute the processor-readable instructions, which when executed by the at least one processor configures the at least one processor to perform a plurality of functions, including functions for: receiving external operational data associated with operation of a vehicle; detecting loading of one or more applications associated with the operation of the vehicle; capturing one or more interactions between an operator of the vehicle and the one or more applications at the vehicle; logging anomalies data associated with the operation of the vehicle, based on any anomaly identified from the received external operational data, the detected loading of the one or more applications, or the captured one or more interactions; recording the received external operational data, the detected loading of the one or more applications, the captured one or more interactions, and/or the logged anomalies data, to generate recorder data; and storing the generated recorder data in one or more vehicle data recorder databases.

In accordance with another embodiment, a non-transitory computer-readable medium containing instructions is disclosed for automatically capturing and recording anomalies and vehicle operator interaction data. The non-transitory computer-readable medium may comprise instructions for: receiving external operational data associated with operation of a vehicle; detecting loading of one or more applications associated with the operation of the vehicle; capturing one or more interactions between an operator of the vehicle and the one or more applications at the vehicle; logging anomalies data associated with the operation of the vehicle, based on any anomaly identified from the received external operational data, the detected loading of the one or more applications, or the captured one or more interactions; recording the received external operational data, the detected loading of the one or more applications, the captured one or more interactions, and/or the logged anomalies data, to generate recorder data; and storing the generated recorder data in one or more vehicle data recorder databases.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an overview of an example environment at a vehicle, in which systems, methods, and other aspects of the present disclosure may be implemented.

FIG. 2 depicts a block diagram schematically showing an exemplary data flow by which a pilot interactivity data and anomalies data are captured using an electronic flight bag (EFB) system, according to one or more embodiments.

FIG. 3 depicts a flowchart of an exemplary method for automatically capturing and recording anomalies and vehicle operator interaction data, according to one or more embodiments.

FIG. 4 depicts an exemplary computer device or system, in which embodiments of the present disclosure, or portions thereof, may be implemented.

### DETAILED DESCRIPTION OF EMBODIMENTS

As described above, the current vehicle operational data analysis systems, such as FOQA systems, often rely on analyzing data relating to external events during the operation (e.g., weather-related events), outputs of vehicle sensors, and/or operations of LRUs during the vehicle's operation. However, the quality of a vehicle operation may also be affected significantly by how the vehicle operator interacts with software applications such as EFB applications. For example, in aviation, even though an aircraft system configuration may remain the same, applications loaded and utilized at the EFB may be constantly changing throughout a particular flight, as a pilot may access and load various applications as needed (e.g., digital charts, crew ops manual, checklists, weather performance, efficiency-related applications, etc.). The level of aptness in such use of these applications may be an important factor in the post-flight analytics.

Thus, if a vehicle operator's interactions with these software applications are electronically captured and made available for correlation with other recorded operational data (e.g., data stored at QAR during a flight), post-operation analysis may be improved in various ways. For example, safety analysis may be enhanced in a post-flight analysis by correlating (e.g., by time or event) captured pilot actions with the SOPs and identifying training gaps for pilots based on assessing the level of compliance. As another example, EFB applications' inputs, responses, and other behaviors may help identify anomalies, thereby identifying specific areas that need improvement. An assessment of vehicle operators' interactions with applications may also facilitate with implementation of efficiency KPIs (key performance indicators), incident analysis, and ERM (enterprise risk management) assessment.

Accordingly, the following embodiments describe systems and methods for automatically recording interactivity and anomaly data at a vehicle, based at least in part on electronically capturing and storing the vehicle operator's interactions with applications. The applications being utilized, in accordance with the present disclosure, may be software applications stored at EFBs or any other computing device used by a vehicle operator during operation of the vehicle. As described in more detail below, capturing and recording how the vehicle operator interacted with applications, in accordance with the present disclosure, may result in improvement in the vehicle operational data analysis technology in various aspects, by uniquely automating a series of data capturing activities, enabling the captured data to correlate with other records of vehicle events, and automatically bolstering electronic records that are generated during a vehicle operation. In this way, a specifically customized use of an electronic data recorder practically applied to a uniquely automated process of capturing, storing, and generated analytics data, is an unconventional automation technique which necessarily achieves functional improvements in computer-implemented analytics generating technology (e.g., through the specific process described in more detail below), in a sharp contrast to merely providing a well-known or routine environment for performing a manual task.

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

While devices with aerospace-specific terminology (e.g., flight data acquisition unit, aircraft interface device, EFB systems, etc.) are referenced throughout the application, devices in other types of vehicles may also perform the functions of capturing and recording anomalies and vehicle operator interaction data. For example, an on-board computer-implemented controller or a portable computing device being used in a non-aerospace vehicle (e.g., automobiles or vessels) may include software applications that a driver, operator, or a vehicle engineer would interact with, and a database in communication with such a device may store electronic records capturing these interactions in the same manner without departing from the scope of the disclosure.

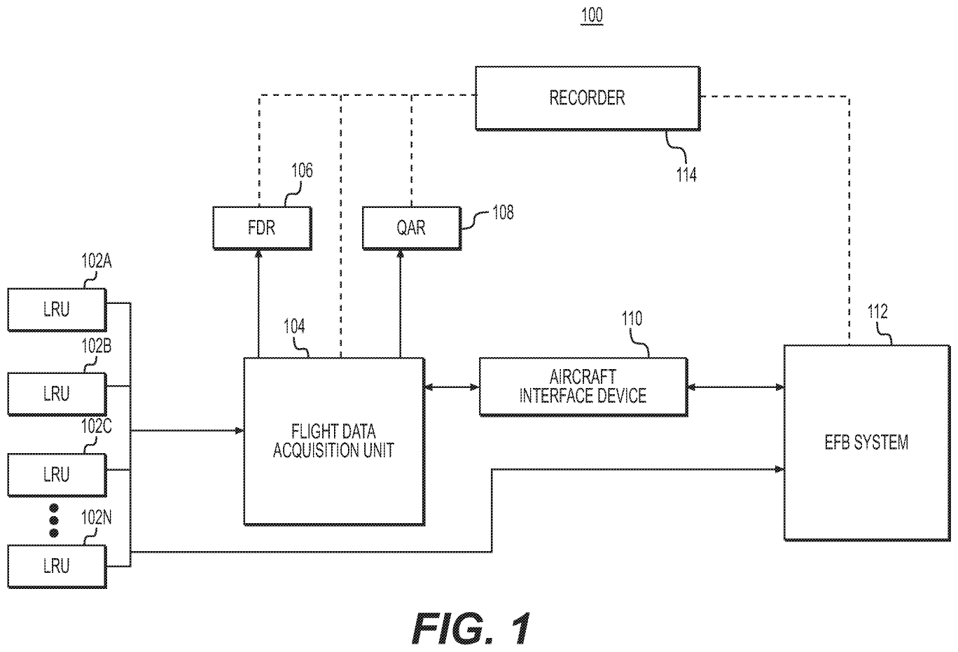

Referring now to the appended drawings, FIG. 1 shows an overview of an example environment 100 at a vehicle, according to one or more embodiments of the present disclosure. The example environment 100 may include a plurality of LRUs 102A-102N, flight data acquisition unit 104, flight data recorder (FDR) 106, QAR 108, aircraft interface device 110, EFB system 112, and a recorder 114.

The plurality of LRUs 102A-102N may be modular components physically installed or mounted at the vehicle hosting the example environment 100 in order to, for example, monitor and/or control the vehicle. The plurality of LRUs 102A-102N may include, for example, aircraft sensors, radio equipment, and avionic systems. The plurality of LRUs 102A-102N may be in communication with flight data acquisition unit 104. Data communications in embodiments of the present disclosure, such as the communication between the LRUs 102A-102N, may be wired or wireless data connections. For example, wired data connections may include Ethernet (such as 10/100BaseT), A429, A717 (QAR) data, GPS data, high or low speed avionics recording, discretes (such as “Weight on Wheels,” LRU Mode Selectors), RS422 (available, such as Aircraft Condition Monitoring System). Wireless data connections may include one or more antennas (such as external client antenna, cabin WAP antenna, belly WAP Antenna), which may be able to connect to either Wi-Fi or cellular. The plurality of LRUs 102A-102N may be configured to provide external operational data (e.g., data detected or generated by avionic systems and sensors) to other components capable of recording or utilizing the external operational data (e.g., flight data acquisition unit 104 or EFB system 112).

The flight data acquisition unit 104 may be a device configured to electronically receive discrete, analog, and digital data from the plurality of LRUs 102A-102N. After receiving the data parameters, the flight data acquisition unit 104 may route the data to FDR 106 and/or QAR 108. In some implementations, the flight data acquisition unit 104 may include a transmitter, a receiver, and/or a routing device capable of receiving, transmitting, processing or passing data signals being exchanged with LRUs 102A-102N, FDR 106, and/or QAR 108. As shown in FIG. 1, the flight data acquisition unit 104 may be in communication with, and be interfacing with, the FDR 106 and/or the QAR 108. Additionally, or alternatively, the flight data acquisition unit 104 may include the FDR 106 and QAR 108.

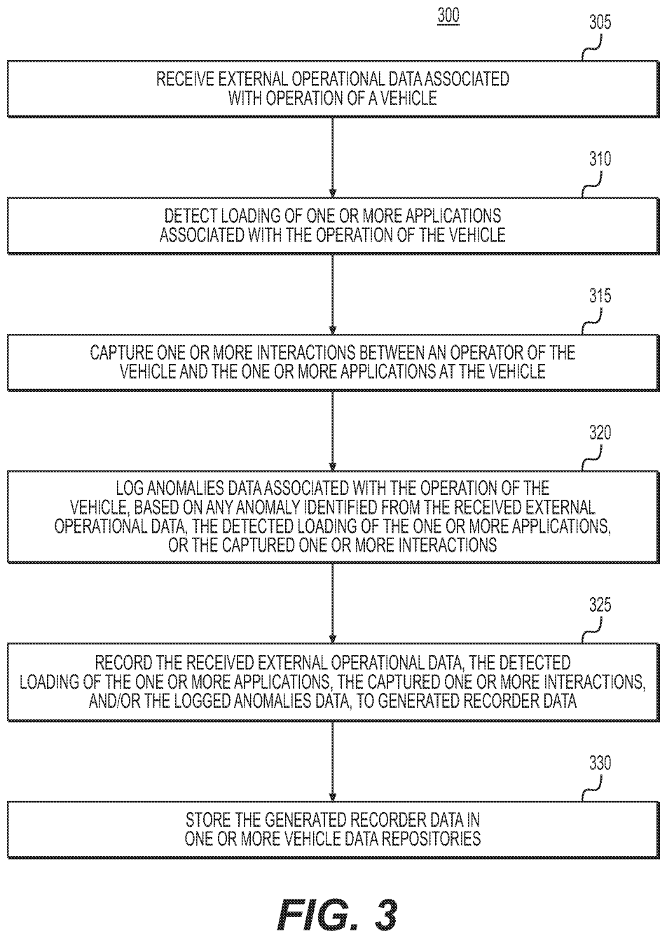

The FDR 106 may be an electronic recording device placed in an aircraft for storing data that may facilitate with investigation of aviation accidents and incidents. Accordingly, the FDR 106 may be configured to store safety critical data, as discussed in more detail below with regard to FIG. 3. Additionally, the FDR 106 may also be configured to receive and store any other types of data associated with flight operations, such as data produced using the EFB system 112.

The QAR 108 may be an electronic recording device that may be configured to record output signals and raw data originating from the plurality of LRUs 102-102N, as well as actuators, valves, sensors, and other various components of a vehicle to determine any indication of legitimate faults. Additionally, the QAR 108 may also be configured to receive and store any other types of data associated with flight operations, such as data produced using the EFB system 112.

The aircraft interface device 110 may be an onboard device included in the vehicle. The aircraft interface device 110 may be connected to one or more of the plurality of LRUs 102A-102N (e.g., avionics systems and sensors) as well as one or more other electronic devices that may receive electronic data (e.g., the EFB system 112). Using these connections, the aircraft interface device 110 may convert data, at least in part, from raw avionic data produced by the connected LRUs into other readable forms for connected devices, such as, for example, the EFB system 112. The specific data types handled by this conversion process may depend on preset configurations and settings programmed at the aircraft interface device 110. In some implementations, each LRU that may provide raw avionic data to other components of the exemplary environment 100 may be individually wired to the aircraft interface device 110. The aircraft interface device 110 may also comprise a processor or a router that is configured by machine readable instructions to convert or decode raw avionics data.

The EFB system 112 may be a computing device that includes one or more applications installed therein, and may be in communication with the aircraft interface device 110, the plurality of LRUs 102A-102N, and the recorder 114. The EFB system 112 may be connected to these components by either a wired connection or a wireless connection. The applications installed at the EFB system 112 may interface with one or more pilots operating a vehicle (e.g., aircraft). For example, applications loaded and utilized at the EFB system 112 may be constantly changing throughout a particular flight, as a pilot may access and load various applications as needed (e.g., digital charts, crew ops manual, checklists, weather performance, efficiency-related applications, etc.).

The recorder 114 may record and store data including, for example, anomaly identified at the EFB system 112 and interactivity of the vehicle operators detected at the EFB system 112. For example, the recorder 114 may register loading of an application at the EFB system 112, record the application interactivity and data display at the EFB system 112, capture and store application behaviors, store external data (e.g., avionics data from the LRUs 102A-102N and/or record anomalies identified (e.g., vehicle-related anomalies entered by crew, anomalies associated with EFB applications' behaviors, etc.). The memory device that stores such data may be, for example, one or more vehicle data recorder databases that is coupled to the recorder 114. The recorder 114 may be in communication with one or more vehicle data recorder databases. In some implementations, the recorder 114 may include the one or more vehicle data recorder databases.

As shown in FIG. 1, the recorder 114 may be in communication with the EFB system 112, the FDR 106, the QAR 108, and/or the flight data acquisition unit 104. Additionally, or alternatively, the recorder 114 may be included in (e.g., installed in) any one or more of the EFB system 112, the FDR 106, the QAR 108, and/or the flight data acquisition unit 104. In some implementations, the recorder 114 may be connected to the EFB system 112, the FDR 106, the QAR 108, and/or the flight data acquisition unit 104 via a separate channel, while the one or more vehicle data recorder databases may be included in the EFB system 112, the FDR 106, the QAR 108, and/or the flight data acquisition unit 104. Alternatively, both the recorder 114 and the one or more vehicle data recorder databases may be connected to other components of the environment 100 via a separate channel.

The recorder 114 may allow its configurations to be customized, with operator preferences, settings, firmware, software applications, and machine-readable instructions. Accordingly, the recorder 114 may transmit (e.g., to the QAR or the FDR, or to an on-board gateway device which may be installed at the EFB system 112) the logged or recorded data periodically and/or as a response to triggering events, based on the operator preferences and/or settings (e.g., frequency of the transmission). The recorder 114 may be configured to record pilot interactions with the applications on the EFB system 112, the external data being used by various applications on the EFB system 112, computed results from the EFB system 112, and/or any faults, errors, or anomalies associated with the applications on the EFB system 112.

The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

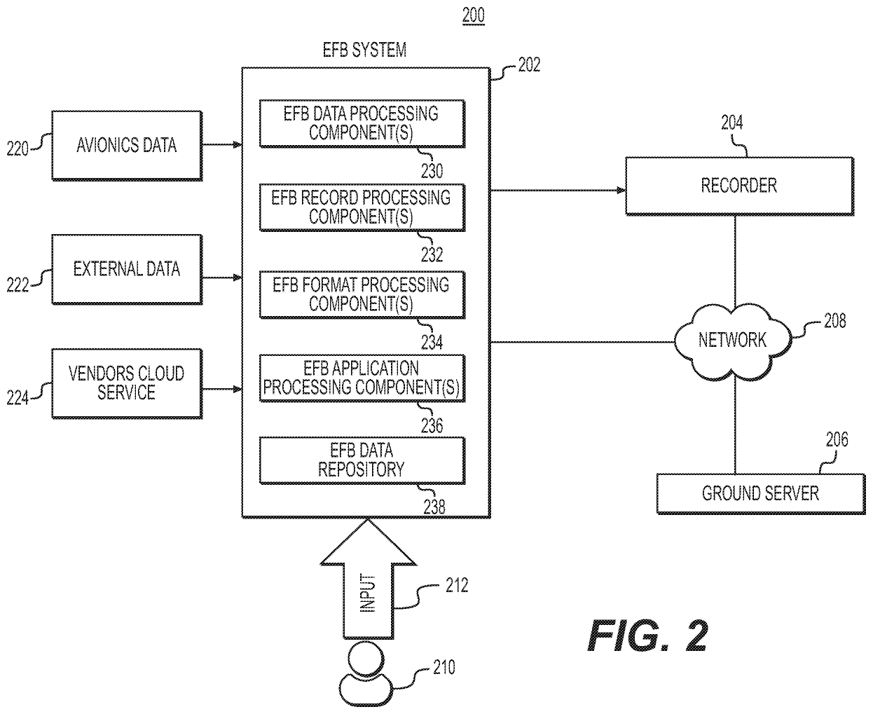

FIG. 2 depicts a block diagram 200 schematically showing an exemplary data flow by which a pilot interactivity data and anomalies data are captured using an electronic flight bag (EFB) system, according to one or more embodiments. In some implementations, the EFB system 202 may correspond to the EFB system 112 shown in FIG. 1.

The EFB system 202 may receive different types of data, such as, for example, avionics data 220, external data 222, and vendors cloud service data 224. The avionics data 220 may include, for example, data output by LRUs 102A-102N (e.g., data detected or generated by avionic systems and sensors of the aircraft). The external data 222 may include any data originating from sources external to the vehicle, such as, for example, data output by external sensors, data transmitted from the ground server 206 over network 208, data transmitted from other vehicles or other servers, etc. The vendors cloud service data 224 may include data received from vendor services, such as subscribed data loaded onto applications on EFB system 202, weather data for integrating weather on a moving map, data associated with airports or departure/arrival facilities, etc.

The EFB system 202 may also be configured to detect, receive, capture, and/or log user inputs 212 from one or more users 210. The user inputs may include, for example, inputs detected via touch interface, voice interface, gesture interface, or any other types of interface by which an operator may interact with the EFB system.

The EFB system 202 may include various components, such as EFB data processing component(s) 230, EFB record processing component(s) 232, EFB format processing component(2), EFB application processing component(s) 236, and EFB data repository 238. The EFB data processing component(s) 230 may be one or more components that receive incoming data (e.g., avionics data 220, external data 222, and vendors cloud service data 224) and process data in a readable and operable form that is suitable for use by EFB applications.

The EFB record processing component(s) 232 may be, for example, one or more components configured to capture and log recorder data, such as pilot interactions with the EFB applications, the external data being used by the EFB applications, computed results from the EFB system 202, and/or any faults, errors, or anomalies associated with the EFB applications. For example, data snapshots, key stroke logs, time stamped logs associated with EFB application usage (e.g., elapsed time since the last user input), captured records of any form from the touch interface, voice interface, gesture interface, or other input interface with the users at the EFB system 202 may be processed and/or stored by the EFB record processing component(s) 232. The EFB record processing component(s) 232 may also be configured to correlate the recorder data with raw vehicle operational data stored at the FDR 106 or QAR 108 of the vehicle. Such a correlation may be, for example, a correlation by timestamp, a correlation by event, or any other type of classification and/or grouping made among the grouping data and the raw vehicle operational data.

The EFB format processing component(s) 234 may be configured to, for example, interpret, decode, convert, or process raw data (e.g., incoming data 220-224 or processed incoming data from EFB data processing component(s) 230) into a file format that is readable by users, analysts, or vehicle components outside of the EFB system 202. For example, the EFB format processing component(s) 234 may include a software module, such as a data interpreter, that may be configured to interpret the raw vehicle data that is received by the EFB format processing component(s) 234. The EFB format processing component(s) 234 may then decode the interpreted vehicle data, to, for example, actionable vehicle parameters. The actionable vehicle parameters may comprise data parameters relevant to the vehicle, such as, for example, speed and travel path.

The EFB application processing component(s) 236 may be configured to identify the EFB application-specific information that may be recorded in the EFB record processing component(s) 232. The EFB application processing component(s) 236 may maintain a registry of all the applications installed in the EFB system 202, the inputs that are to be provided to the application, and the data produced by the application. The EFB application processing component(s) 236 may extract the received input data and the computed output and may send each to the EFB record processing component(s) 232 during both background application processing and during active usage of the application by the user. The EFB application processing component(s) 236 may also identify any anomalies detected in the application being executed. For example, an application in the EFB system 202 that provides an optimized flight level may be monitored by the EFB application processing component(s) 236 for activation by the user or any other application in the EFB system 202. Once activated, EFB application processing component(s) 236, through inter process communication, may extract the inputs received by the application and the corresponding output generated by the application. The received inputs may include, for example, configuration settings, flight plan information, weather and traffic information, current aircraft state information, or the like. The generated output may include, for example, the optimum flight level(s), optimized flight trajectory, summary of the optimized flight, or the like. The application information, timestamp, inputs, and outputs may be sent to the EFB record processing component(s) 232.

The EFB data repository 238 may include register(s) and/or database(s) for data that need to be saved at the EFB system 202. For example, the one or more vehicle data recorder databases coupled to the recorder 114, described in detail above with respect to FIG. 1, may be included in the EFB data repository 238.

The EFB system 202 may transmit recorder data, such as received external operational data, detected loading of one or more applications associated with the operation of the vehicle, captured interactions between an operator of the vehicle and the one or more EFB applications, and/or logged anomalies data (e.g., any anomaly identified from the received external operational data, the detected loading of the one or more applications, or the captured one or more interactions), to the recorder 204. In some implementations, the recorder 204 may correspond to recorder 114 described in more detail above with respect to FIG. 1. The recorder 204 may store the recorder data at one or more vehicle data recorder databases, which may be included in, for example, QAR 108, FDR 106, EFB system 202, an on-board gateway device (e.g., Aircraft Data Gateway-300 manufactured by Honeywell International Inc.), flight data acquisition unit 104, a data repository in communication with a cloud network (e.g., network 208), or a ground server 206.

For communications that occur among the EFB system 202, recorder 204, and/or ground server 206, network 208 may be used. The network 208 may include, for example, ACARS (aircraft communications addressing and reporting system) or SATCOM (communications satellite). The network 108 may also include, for example, one or more of a cellular network, a public land mobile network, a local area network, a wide area network, a metropolitan area network, a telephone network, a private network, an ad hoc network, an intranet, the Internet, a fiber optic based network, a cloud computing network, etc.

FIG. 3 depicts a flowchart of an exemplary method 300 for automatically capturing and recording anomalies and vehicle operator interaction data, according to one or more embodiments. The exemplary method 300 may be performed by one or more processors in one or more of the flight data acquisition unit 104, the EFB system 112, the EFB system 202, the recorder 114, the recorder 204, and/or ground server 206. In some implementations, the exemplary method 300 may be performed by one or more processors in the EFB system 202, and the EFB system 202 may correspond to the EFB system 112.

The one or more processors may first receive external operational data associated with operation of a vehicle (Step 305). For example, the external operational data may be received from one or more LRUs of the vehicle. The one or more processors may also detect loading of one or more applications associated with the operation of the vehicle (Step 310). When loading of the one or more applications have been detected, the one or more processors may capture one or more interactions between an operator of the vehicle and the one or more applications at the vehicle (Step 315). The one or more processors may, in response, log anomalies data associated with the operation of the vehicle, based on any anomaly identified from the received external operational data, the detected loading of the one or more applications, or the captured one or more interactions (Step 320). The one or more processors may record the received external operational data, the detected loading of the one or more applications, the captured one or more interactions, and/or the logged anomalies data, to generate recorder data (Step 325). The one or more processors may store the generated recorder data in one or more vehicle data recorder databases (Step 330).

The one or more vehicle data recorder databases may be databases included in, for example, QAR 108, FDR 106, EFB system 112, an on-board gateway device (e.g., Aircraft Data Gateway-300 manufactured by Honeywell International Inc.), flight data acquisition unit 104, a data repository in communication with a cloud network (e.g., network 208), or the ground server 206. Storing of the generated recorder data may include, for example, transmitting, by the one or more processors, the generated recorder data to the one or more vehicle recorder databases periodically, based on a frequency identified from an operator preference data set. If the generated recorder data are to be stored at the FDR 106 or QAR 108 (e.g., by pre-configuration, preference data, or user input), then the one or more processors may transmit the generated recorder data via an aircraft interface device (AID) of the vehicle. In some implementations, the one or more processors may, for example, correlate the generated recorder data with raw vehicle operational data stored at a QAR of the vehicle. In some implementations, the one or more processors may determine that the generated recorder data include safety critical data, and in response, store the generated recorder data in FDR 106.

Although FIG. 3 shows example blocks of method 300, in some implementations, process 300 may include additional blocks, fewer blocks, different blocks, or differently arranged blocks than those depicted in FIG. 3. Additionally, or alternatively, two or more of the blocks of process 300 may be performed in parallel.

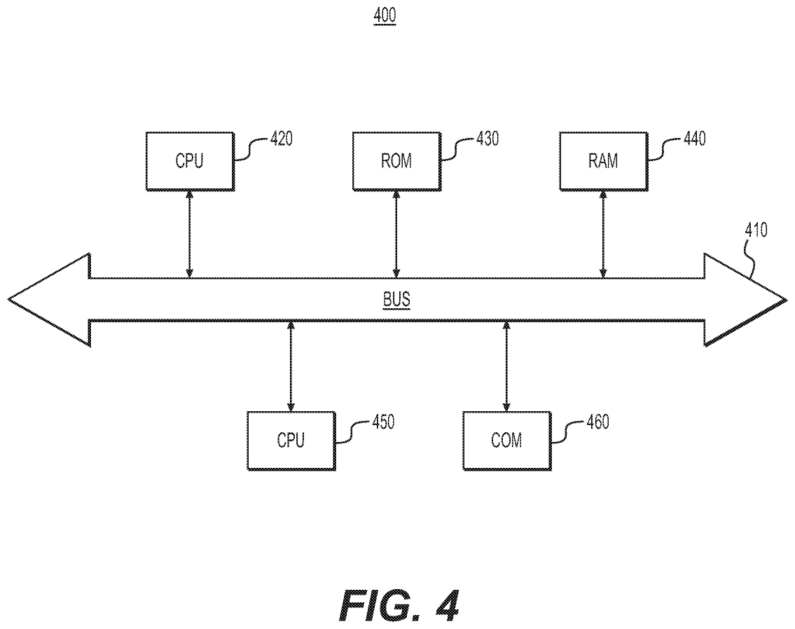

FIG. 4 depicts a high-level functional block diagram of an exemplary computer device or system, in which embodiments of the present disclosure, or portions thereof, may be implemented, e.g., as computer-readable code. In some implementations, the flight data acquisition unit 104, FDR 106, QAR 108, EFB system 112, and/or recorder 114 (depicted in FIG. 1) may correspond to device 400. Additionally, or alternatively, EFB system 202, recorder 204, and/or ground server 206 (depicted in FIG. 2) may correspond to device 400. Additionally, each of the exemplary computer servers, databases, user interfaces, modules, and methods described above with respect to FIGS. 1-3 can be implemented in device 400 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-3.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

Various embodiments of the present disclosure, as described above in the examples of FIGS. 1-3, may be implemented using device 400. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 4, device 400 may include a central processing unit (CPU) 420. CPU 420 may be any type of processor device including, for example, any type of special purpose or a general-purpose microprocessor device. As will be appreciated by persons skilled in the relevant art, CPU 420 also may be a single processor in a multi-core/multiprocessor system, such system operating alone, or in a cluster of computing devices operating in a cluster or server farm. CPU 420 may be connected to a data communication infrastructure 410, for example, a bus, message queue, network, or multi-core message-passing scheme.

Device 400 also may include a main memory 440, for example, random access memory (RAM), and also may include a secondary memory 430. Secondary memory 430, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 430 may include other similar means for allowing computer programs or other instructions to be loaded into device 600. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 400.

Device 400 also may include a communications interface (“COM”) 460. Communications interface 460 allows software and data to be transferred between device 400 and external devices. Communications interface 460 may include a modem, a network interface (such as an Ethernet card), a communications port, a PCMCIA slot and card, or the like. Software and data transferred via communications interface 460 may be in the form of signals, which may be electronic, electromagnetic, optical, or other signals capable of being received by communications interface 460. These signals may be provided to communications interface 460 via a communications path of device 400, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It is intended that the specification and examples be considered as exemplary only, with a true scope and spirit of the disclosure being indicated by the following claims.

What is claimed is:

1. A computer-implemented method for automatically capturing and recording anomalies and vehicle operator interaction data comprising:
receiving, by one or more processors, external operational data associated with operation of a vehicle;
detecting, by the one or more processors, loading of one or more applications associated with the operation of the vehicle;
capturing, by the one or more processors, one or more interactions between an operator of the vehicle and the one or more applications at the vehicle;
logging, by the one or more processors, anomalies data associated with the operation of the vehicle, based on any anomaly identified from the received external operational data, the detected loading of the one or more applications, or the captured one or more interactions;
recording, by the one or more processors, the received external operational data, the detected loading of the one or more applications, the captured one or more interactions, and/or the logged anomalies data, to generate recorder data; and
storing, by the one or more processors, the generated recorder data in one or more vehicle data recorder databases.

2. The method of claim 1, further comprising:
correlating, by the one or more processors, the generated recorder data with raw vehicle operational data stored at a quick access recorder (QAR) of the vehicle.

3. The method of claim 1, wherein the external operational data is received from one or more line-replaceable units (LRUs) of the vehicle.

4. The method of claim 1, wherein the one or more vehicle data recorder databases are included in at least one of: a quick access recorder (QAR), a flight data recorder (FDR), an electronic flight bag (EFB) system, an on-board gateway device, a flight data acquisition unit, a data repository in communication with a cloud network, or a ground server.

5. The method of claim 4, further comprising:
determining, by the one or more processors, that the generated recorder data include safety critical data; and
in response to determining that the generated recorder data include safety critical data, storing, by the one or more processors, the generated recorder data in the FDR.

6. The method of claim 4, wherein the storing the generated recorder data further comprises:
transmitting, by the one or more processors, the generated recorder data to the QAR and/or the FDR, via an aircraft interface device (AID) of the vehicle.

7. The method of claim 1, wherein the storing the generated recorder data further comprises:
transmitting, by the one or more processors, the generated recorder data to the one or more vehicle recorder databases periodically, based on a frequency identified from an operator preference data set.

8. A computer system for using automatically capturing and recording anomalies and vehicle operator interaction data, the system comprising:
a memory having processor-readable instructions stored therein; and
at least one processor configured to access the memory and execute the processor-readable instructions, which when executed by the processor configures the processor to perform a plurality of functions, including functions for:
receiving external operational data associated with operation of a vehicle;
detecting loading of one or more applications associated with the operation of the vehicle;
capturing one or more interactions between an operator of the vehicle and the one or more applications at the vehicle;
logging anomalies data associated with the operation of the vehicle, based on any anomaly identified from the received external operational data, the detected loading of the one or more applications, or the captured one or more interactions;
recording the received external operational data, the detected loading of the one or more applications, the captured one or more interactions, and/or the logged anomalies data, to generate recorder data; and
storing the generated recorder data in one or more vehicle data recorder databases.

9. The system of claim 8, wherein the plurality of functions include a function for:
correlating the generated recorder data with raw vehicle operational data stored at a quick access recorder (QAR) of the vehicle.

10. The system of claim 8, wherein the external operational data is received from one or more line-replaceable units (LRUs) of the vehicle.

11. The system of claim 8, wherein the one or more vehicle data recorder databases are included in at least one of: a quick access recorder (QAR), a flight data recorder (FDR), an electronic flight bag (EFB) system, an on-board gateway device, a flight data acquisition unit, a data repository in communication with a cloud network, or a ground server.

12. The system of claim 11, wherein the plurality of functions include functions for:
determining that the generated recorder data include safety critical data; and
in response to determining that the generated recorder data include safety critical data, storing the generated recorder data in the FDR.

13. The system of claim 11, wherein the function for storing the generated recorder data further comprises:
transmitting the generated recorder data to the QAR and/or the FDR, via an aircraft interface device (AID) of the vehicle.

14. The system of claim 8, wherein the function for storing the generated recorder data further comprises:
transmitting the generated recorder data to the one or more vehicle recorder databases periodically, based on a frequency identified from an operator preference data set.

15. A non-transitory computer-readable medium containing instructions for automatically capturing and recording anomalies and vehicle operator interaction data, comprising:
receiving external operational data associated with operation of a vehicle;
detecting loading of one or more applications associated with the operation of the vehicle;
capturing one or more interactions between an operator of the vehicle and the one or more applications at the vehicle;
logging anomalies data associated with the operation of the vehicle, based on any anomaly identified from the received external operational data, the detected loading of the one or more applications, or the captured one or more interactions;
recording the received external operational data, the detected loading of the one or more applications, the captured one or more interactions, and/or the logged anomalies data, to generate recorder data; and
storing the generated recorder data in one or more vehicle data recorder databases.

16. The computer-readable medium of claim 15, wherein the instructions further comprise:
correlating the generated recorder data with raw vehicle operational data stored at a quick access recorder (QAR) of the vehicle.

17. The computer-readable medium of claim 15, wherein the external operational data is received from one or more line-replaceable units (LRUs) of the vehicle.

18. The computer-readable medium of claim 15, wherein the one or more vehicle data recorder databases are included in at least one of: a quick access recorder (QAR), a flight data recorder (FDR), an electronic flight bag (EFB) system, an on-board gateway device, a flight data acquisition unit, a data repository in communication with a cloud network, or a ground server.

19. The computer-readable medium of claim 18, wherein the instructions further comprise:
determining that the generated recorder data include safety critical data; and
in response to determining that the generated recorder data include safety critical data, storing the generated recorder data in the FDR.

20. The computer-readable medium of claim 18, wherein the instructions further comprise:
transmitting the generated recorder data to the QAR and/or the FDR, via an aircraft interface device (AID) of the vehicle.
